(19) United States
(12) Patent Application Publication
(10) Pub. No.: US 2011/0290128 A1
(43) Pub. Date: Dec. 1, 2011

(54) DEVICE AND A METHOD FOR FEEDING DAMPENING SOLUTION IN AN OFFSET PRINTING UNIT

(75) Inventors: Birger Hansson, Akarp (SE); John MacPhee, Rowayton, CT (US)

(73) Assignee: Baldwin Jimek AB, Arlov (SE)

(21) Appl. No.: 13/131,156

(22) PCT Filed: Nov. 25, 2009
(86) PCT No.: PCT/EP2009/065813

§ 371 Date: Aug. 16, 2011

Related U.S. Application Data
(60) Provisional application No. 61/117,765, filed on Nov. 25, 2008.

(30) Foreign Application Priority Data
Nov. 25, 2008 (EP) 08169902.7

(51) Int. Cl. B41L 25/06

(52) U.S. Cl. 101/147

(57) ABSTRACT

A device for feeding dampening solution in an offset printing unit is presented. The device comprises a plurality of nozzles (22), each of which comprises an orifice (24), wherein each nozzle (22) is configured to eject a solitary droplet of dampening solution of a predetermined volume through said orifice (24) to a roller/cylinder (2, 5) of said offset printing unit, and a control means connected to the plurality of nozzles (22) and programmed to allow a predetermined number of nozzles to eject solitary droplets such that a film of dampening solution is provided across hydrophobic areas and hydrophilic areas of a printing plate of said offset printing unit.

### TECHNICAL FIELD

The present invention relates to a device for feeding dampening solution in an offset printing unit, and a printing unit of the offset-type comprising such device. Furthermore, the invention concerns a method for feeding dampening solution in an offset printing unit as well as the use of the device for feeding dampening solution.

### BACKGROUND

Offset printing units are widely used for high-volume commercial and newspaper printing, due to the high printing quality produced by such printers, while still providing a cost-efficient alternative for large volumes. The printing units employed in newspaper printing are usually of the web-fed type wherein the paper on which they are printed is supplied in the form of rolls and passes through the press in web form. In contrast, commercial printing employs units of either the web-fed or sheet-fed type, depending on the number of copies required.

In offset printing, an inked image is transferred from a printing plate to a blanket cylinder, which is in contact with the surface of the paper to be printed. The printing plate is mounted on a cylinder being in contact with inking rollers feeding ink to the plate cylinder, and dampening rollers feeding dampening solution to the complete surface of the plate cylinder. The plate cylinder is provided with a printing plate arranged on the surface of the plate cylinder. The printing plate comprises hydrophobic areas as well as hydrophilic areas. The hydrophobic areas of the printing plate preferentially attract ink, and the hydrophilic areas of the printing plate preferentially attract dampening solution.

For newspaper or commercial printing, the dampening solution used is a low viscosity fluid containing mostly water. In contrast, lithographic inks have relatively high viscosities and therefore have a high resistance to flow. Lithographic inks also vary in the way in which they are dried or cured. E.g., most newspaper inks are cured by absorption into the paper. Further, most commercial sheet-fed inks are cured by an oxidation process, and most commercial web-fed inks are cured using a heating process.

In many applications the dampening solution emulsifies into the ink by a specific degree, e.g. 5 to 25% depending on the specific application.

Different methods for feeding the dampening solution to the complete surface of the plate cylinder are described in prior publications. Regardless of the type of system used for feeding, the amount of dampening solution required in offset printing units is equivalent to a web, or thin film, of dampening solution across the complete width of the press, having a thickness of about 0.2 micrometers, and traveling at the speed of the press. Thus, the volumetric flow rate of dampening solution into the press must be increased as press speed is increased. FIG. 1 is a schematic diagram that shows the main features of spray type dampening systems currently used in the printing industry. FIG. 1 shows a plate cylinder 2 of a printing unit and the dampening rollers 5a and 5b that transfer damping solution to it. The dampening solution is fed under high pressure from a fluid supply system 40 to a spray bar 30 consisting of a linear array of solenoid operated valves fitted with special nozzles 33. When the valves are opened by a signal from the control system 40, dampening solution is ejected at a constant flow rate into the air, in the form of jets, towards the dampening roller 5a. Upon exiting the nozzles the jets are atomized to produce fan shaped streams containing a multitude of tiny droplets, most of which strike and adhere to dampening roller 5a. The dampening solution is then transferred to the plate, via dampening roller 5b. Because the flow rate of solution exiting the nozzles is much higher than what is actually needed the valves must be pulsed or turned off and on periodically so as not to feed an excess of dampening solution to the plate. The volumetric flow rate to the dampening roller is varied by changing the frequency at which the nozzles are pulsed, which can be done with manual controls or automatically in response to a signal from a press speed sensor 60. The manual controls allows the press operator to adjust the flow rate of dampening solution so as to achieve acceptable print quality while the automatic adjustment relieves him of the task of making adjustments whenever press speed is changed.

Spray dampening systems of the type illustrated in FIG. 1 are widely used and have been found to be highly satisfactory when printing on uncoated paper such as used for newspapers, telephone directories, and some direct mailings. Although some good results have also been achieved using spray dampening systems in commercial printing, their use has been limited to commercial presses of the web-fed type, with no known successful usage on a sheet-fed press. The main reason for this low usage of spray dampeners in commercial printing is because of the higher print quality requirements of commercial printing, which in general is difficult to achieve using spray dampeners. This difficulty arises mainly from the relatively long response time of the solenoid-operated valves used in the spray bar and the relatively low speeds at which most commercial presses operate. Specifically, the solenoid-actuated valves used in the current art cannot be opened for periods shorter than about 5 milliseconds. At the very high speeds at which newspaper and some commercial web presses operate, the required “off” times are short enough that the unevenness of dampening solution flow resulting from pulsing is not severe enough to create a significant problem. However, at the lower speeds at which sheet-fed presses, and some commercial web presses operate, relatively much longer “off” times must be used, producing a greater unevenness in dampening solution flow, in turn resulting in print quality problems that are much more difficult to overcome.

An example of a current art system is disclosed in U.S. Pat. No. 5,025,722, wherein an adjustable spray dampening system is provided having a number of spray nozzles arranged in laterally spaced relationship for spraying dampening solution onto a dampening roller of a printing press. Further, this system involves movements of the nozzles in relation to each other, as well as movements of the nozzles towards and away from the dampening roller.

Another system for spraying dampening solution onto a dampening roller is disclosed in US Patent Application 2005/0115423. This system includes a plurality of spray nozzles arranged in a row for spraying the dampening solution in an increasing fan-shaped area. Further, baffle means are provided to baffle an air stream from being directed toward the nozzle when spraying the dampening solution.

As to background art, JP-A-3035376 should be mentioned as well. This document discloses a nozzle assembly mainly for spraying purposes.

Using the above systems, care must be taken in order to achieve a uniform distribution of dampening solution, especially at the ends of the dampening roller to which the system is feeding dampening solution.

The pulsed mode of operation also makes it impractical to spray dampening solution directly onto the plate of a lithographic press because of the difficulty of preventing dampening solution from entering the gaps existing in the plate cylinders of most such presses. This problem is particularly acute on sheet-fed presses because they have very wide cylinder gaps.

Another problem with existing type spray dampening systems is that the method used to atomize the ejected stream does not produce droplets of uniform size. Drops smaller than the desired size constitute aerosols that can float away and coalesce in unwanted areas, while larger than desired size drops can result in print defects.

Another disadvantage of most existing designs of spray dampening systems is that a separate train of dampening rollers is required to average out or reduce the variations in the thickness of the film of dampening solution, formed by the pulsed volumes of spray, before it is transferred to the plate. Customarily, two such rollers are employed but where greater print quality is required more rollers must be added, resulting in a higher cost. It is also necessary that one of these dampening rollers should oscillate in the lateral direction so as to prevent print defects due to ridging and this requirement adds further to system cost.

Further, it is difficult to perform accurate measurements of the amount of dampening fluid used, which is necessary to control the printing quality. Moreover, the existing systems require highly skilled personnel to adjust the spray nozzle arrangement for obtaining high quality printing quality.

A further disadvantage of spray dampening systems is that a significant amount of sprayed dampening solution must be collected and recycled, particularly at the ends of the dampening roller.

WO 2007/098174 discloses a system for producing multiple copies of a document like a magazine or mailer wherein a different variable image (like a mailing address) can be added to each individual copy. Another feature of the system is that the duplicate images can be printed using the lithographic process so that the high print quality and printing speeds of this process can be maintained. The invention involves using a variation of the ink jet printing process to produce the different variable images on each copy. Thus, this document is directed to incorporating a variable printing technique into an offset printing unit, instead of using an ink jet system to print the variable images directly onto the paper subsequent to the lithographic printing. However, this type of system requires an extensive cleaning system for cleaning the section of the plate bearing the inked variable images, after they have been transferred to the blanket and prior to passing under the ink jet head(s) to receive a new set of variable images.

In view of the above-mentioned prior art, an improved lithographic system allowing for facilitated operation, increased efficiency as well as quality, and lower cost would be advantageous.

### SUMMARY

Accordingly, the present invention seeks to mitigate, alleviate or eliminate one or more of the above-identified deficiencies in the art and disadvantages singly or in any combination and solves at least the above-mentioned problems by providing a device and a method according to the appended claims.

An object according to some embodiments of the invention is to provide a device and method for increasing the accuracy of the dampening solution balance in the across press direction.

Another object according to some embodiments is to provide a device and method for increasing the quality of the printed media.

Another object according to some embodiments is to provide a device and method of supplying droplets of dampening solution to a lithographic printing unit wherein the unevenness at which the droplets are ejected does not change as press speed is reduced.

Another objective is to provide a device and a method of supplying droplets of dampening solution to a lithographic printing unit wherein each drop is of a predetermined size.

Another object according to some embodiments is to provide a device and method of supplying droplets of dampening solution to a lithographic printing unit wherein the droplets can be applied directly to the plate cylinder without the need for intermediate dampening rollers.

Another object according to some embodiments is to provide a device and method of supplying dampening solution to a lithographic printing unit, reducing the need of collecting and recycling excess dampening solution being fed to the printing unit.

An idea according to some embodiments is to provide a device and method for reducing the cost of a spray dampening system.

An idea according to some embodiments is to provide a device and method for a dampening system that can be used on sheet-fed presses.

According to a first aspect, a device for feeding dampening solution in an offset printing unit is provided. The device comprises a plurality of nozzles, each of which comprises an orifice, wherein each nozzle is configured to eject a solitary droplet of dampening solution through said orifice to a roller/cylinder of said offset printing unit.

According to a second aspect, a device for feeding dampening solution in an offset printing unit is provided. The device comprises a plurality of nozzles, each of which comprises an orifice, wherein each nozzle is configured to eject a solitary droplet of dampening solution of a predetermined volume through said orifice to a roller/cylinder of said offset printing unit, and a control means connected to the plurality of nozzles and programmed to allow a predetermined number of nozzles to eject solitary droplets such that a film of dampening solution is provided across hydrophobic areas and hydrophilic areas of a printing plate of said offset printing unit. The device is advantageous in that the feeding of dampening solution is much more uniform and can be controlled in a high resolution, resulting in an accurate measure of the dampening solution usage.

The time required for dispensing each solitary droplet may be between 1 and 500 microseconds, preferably between 5 and 50 microseconds, and most preferred about 10 microseconds. The volume of each solitary droplet that is dispensed may be between 2 and 10000 pico liters, preferably between 4 and 40 pico liters and preferably about 12 pico liters.

Said plurality of nozzles may be comprised in an assembly of ink-jet type, which is advantageous in that existing and easily accessible construction parts are used resulting in a cost-efficient device. In such embodiment, the term “plurality” may be used to denote a quantity greatly in excess of the minimum quantity required for the given application. Said plurality of nozzles are advantageous in that an excess nozzle can be used to take the place of an active nozzle, thereby avoiding the costly need to shut down the press in the event that a nozzle becomes clogged.

Said plurality of nozzles may be arranged in a linear array. Hence, the plurality of nozzles may be arranged to extend over the complete length of the roller/cylinder, thus increasing the operational speed of the device.

Said plurality of nozzles may be arranged in a two-dimensional matrix, which further increases the speed of the device.

Said plurality of nozzles may be arranged longitudinally of a dampening roller of the printing unit for ejecting droplets of dampening solution onto the dampening roller. Furthermore, said plurality of nozzles may be controlled such that the ejected solitary droplets produce a pattern that oscillates in the lateral direction of the dampening roller so as to eliminate print defects. Hence, the number of dampening rollers used in existing systems may be reduced to only one and it need not be of the oscillating type.

Said plurality of nozzles may be arranged longitudinally of a plate cylinder of the printing unit for ejecting droplets of dampening solution onto the plate cylinder, and programmed to be turned off periodically so as not to spray into the plate cylinder gap, This is advantageous in that the complete system of dampening rollers and motors of existing systems can be eliminated.

Each droplet may be ejected in a plane substantially perpendicular to the surface area of said roller/cylinder. Hence, the distance of travel for each droplet from the orifice to the roller means is minimized, resulting in an increased control of the feeding of dampening solution.

According to a third aspect of the invention, a printing unit of the offset-type is provided, comprising a device according to the first or second aspect of the invention. The advantages of the first and second aspects are also applicable for this third aspect of the invention.

According to a fourth aspect of the invention, a method of feeding dampening solution in an offset printing unit is provided. The method comprises the steps of providing a device comprising a plurality of nozzles, each of which comprises an orifice, and ejecting a solitary droplet of dampening solution through each orifice to a roller/cylinder of said offset printing unit.

According to a fifth aspect of the invention, a method of feeding dampening solution in an offset printing unit is provided. The method comprises the steps of providing a device comprising a plurality of nozzles, each of which comprises an orifice, ejecting a solitary droplet of dampening solution through each orifice of a predetermined number of nozzles to a roller/cylinder of said offset printing unit, and equalizing the thickness distribution of the dampening solution such that a film of dampening solution is provided across hydrophobic areas and hydrophilic areas of a printing plate of said offset printing unit.

The advantages of the first and second aspects of the invention are also applicable for these fourth and fifth aspects of the invention.

According to a further aspect of the invention, the use of a device for feeding dampening solution according to the first or second aspect of the invention is provided. The advantages of the first and second aspects of the invention are also applicable for this further aspect of the invention.

### BRIEF DESCRIPTION OF THE DRAWINGS

These and other aspects, features and advantages of which the invention is capable of will be apparent and elucidated from the following description of embodiments of the present invention, reference being made to the accompanying drawings, wherein:

FIG. 1 is a schematic view of a prior art spray type dampening system.

FIG. 2 is a schematic side view of an offset printing unit according to an embodiment;

FIG. 3 is a schematic side view of an offset printing unit according to an embodiment;

FIG. 4 is a perspective view of a device according to an embodiment;

FIG. 5 is a perspective view of the device shown in FIG. 4;

FIG. 6 is a diagram showing the pattern of droplets of dampening solution produced on the plate cylinder in a specific embodiment of the invention; and

FIG. 7 is a diagram showing the pattern of sprayed droplets of dampening solution produced on the plate cylinder by a typical spray type dampening system of the prior art.

FIG. 8 is a schematic view of a control system for an offset printing unit according to an embodiment.

### DETAILED DESCRIPTION

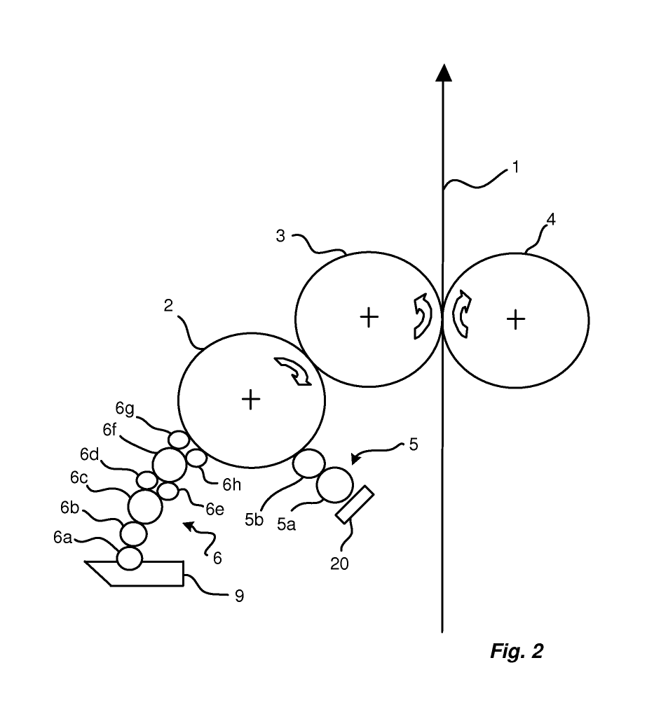

With reference to FIG. 2, a side view of an offset printing unit is schematically shown. A paper web 1 is fed continuously between a blanket cylinder 3 and an impression cylinder 4. The blanket cylinder 3 is rotating counter-clockwise, and the impression cylinder 4 is rotating clockwise, as indicated by the arrows in FIG. 2. A plate cylinder 2, carrying a printing plate (not shown), is provided to transfer an image from the printing plate to the blanket cylinder 3. The plate cylinder 2 is rotating clockwise.

As can be seen in FIG. 2, two different arrangements (20, 5, 9, 6) are provided for supplying dampening solution and ink to the printing plate of the plate cylinder 2. Dampening solution is supplied to the plate cylinder 2 by means of a device 20 connected to a sequence 5 of dampening rollers 5a, 5b. The device 20 is further connected to a dampening solution supply (not shown), for continuously feeding dampening solution to the nozzles. The device 20 comprises a plurality of nozzles (not shown), each nozzle having an orifice for ejecting a sequence of individual and solitary droplets, containing a predetermined volume of dampening solution to the dampening roller 5a of the offset printing unit. Further, a control means (not shown) is connected to the plurality of nozzles and programmed to allow a predetermined number of nozzles to eject solitary droplets. The following dampening roller 5b is provided to equalize the thickness distribution of the dampening solution across the length of the dampening rollers, and to transfer the dampening solution to the plate cylinder 2. Hence, a thin film of dampening solution may be provided across the hydrophobic areas and the hydrophilic areas of the printing plate.

An ink supplying unit 9, 6 includes an ink tray 9 and a sequence 6 of ink rollers 6a-h. A first ink roller 6a is arranged adjacent to the ink tray 9, for receiving a film of ink when the ink roller 6a is rotating. The following ink rollers 6b-6h are arranged to rotate against each other in order to provide a more smooth and thin film of ink. The last ink rollers 6g, 6h of the sequence are rotating against the plate cylinder 2. The ink tray 9 may be changed to an ink screw or any other suitable ink providing unit known per se.

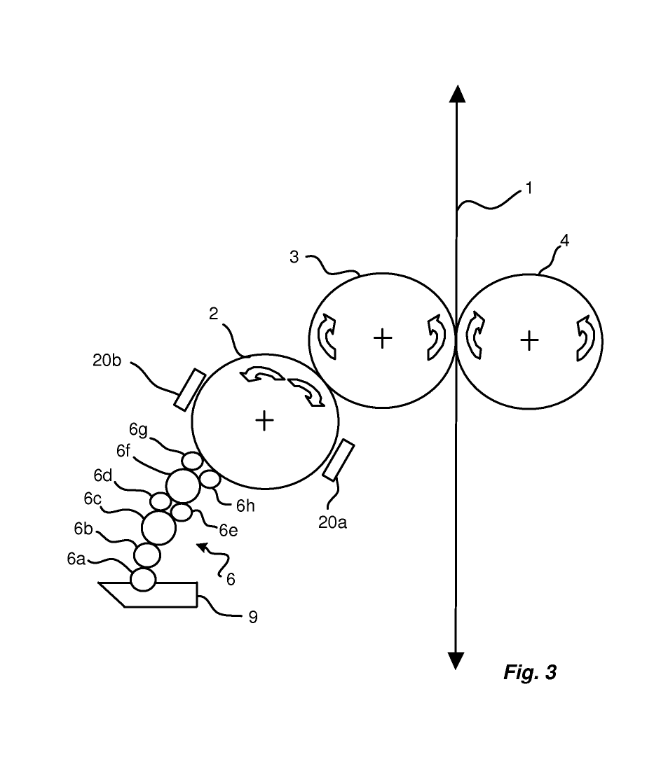

FIG. 3 shows an embodiment of the offset printing unit of FIG. 2. The configuration of the paper web 1, the cylinders 2, 3, 4, and the ink supplying arrangement 9, 6 is equal to what has been previously described with reference to FIG. 2.

Dampening solution is supplied to the plate cylinder 2 by means of a first device 20a, and a second device 20b, said devices 20a, 20b being arranged adjacent to the plate cylinder 2. The devices 20a, 20b are further connected to a dampening solution supply (not shown), for continuously feeding dampening solution to the nozzles. In this embodiment, the first device 20a is arranged on a first side of the ink supplying unit 9, 6, and the second device 20b is arranged on a second side of the ink supplying unit 9, 6. Each device 20a, 20b comprises a plurality of nozzles (not shown), each nozzle having an orifice for ejecting a sequence of individual and solitary droplets, containing a predetermined volume of dampening solution to the plate cylinder 2 of the offset printing unit. Further, a control means (not shown) is connected to the plurality of nozzles of the devices 20a, 20b and programmed to allow a predetermined number of nozzles to eject solitary droplets. As indicated by the arrows in FIG. 3, the paper web 1 can be fed in both directions, and the rollers/cylinders 2, 3, 4, 6 are consequently configured to be rotatable in a clockwise direction, as well as in a counter-clockwise direction. Hence, the described embodiment is advantageous in that dampening solution can be ejected to the plate cylinder 2 before ink is applied, independently of the rotational direction of the plate cylinder 2.

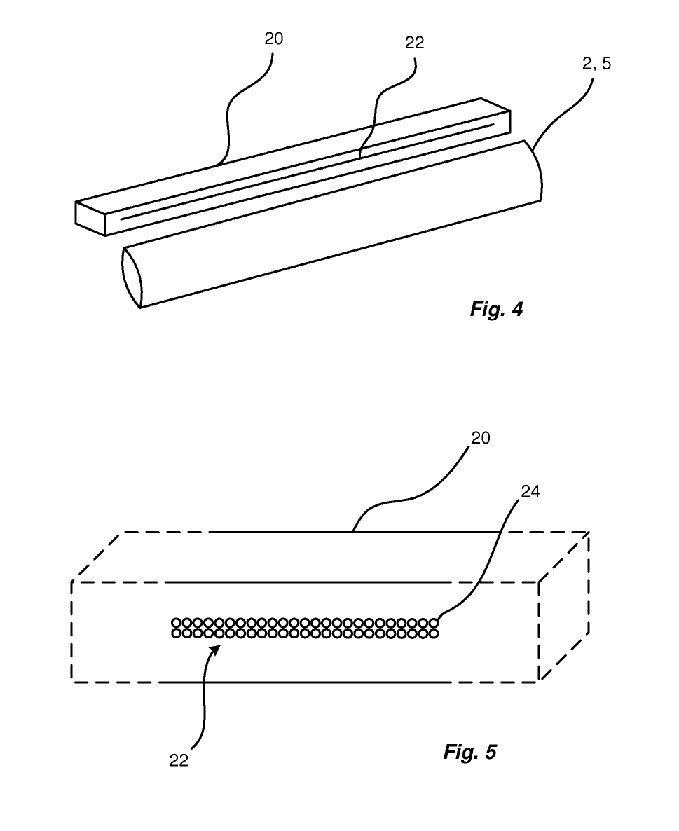

With reference to FIGS. 4 and 5, a device 20 is arranged for feeding dampening solution to a roller/cylinder 2, 5, comprised in an offset printing unit. The device 20 comprises a plurality of nozzles 22, arranged in a linear array extending longitudinally. Each nozzle has an orifice for ejecting a sequence of individual and solitary droplets, containing a predetermined volume of dampening solution to the roller/cylinder 2, 5 of the offset printing unit. It should be appreciated that FIGS. 4 and 5 for illustrative purposes are not to scale.

With reference to FIG. 5, a portion of the device 20 is shown in more detail. Here, the plurality of nozzles 22 is distributed in a two-row matrix, extending longitudinally of said device 20. Upon activation by a control means, each nozzle has an orifice 24 for ejecting a sequence of individual and solitary droplets, containing a predetermined volume of dampening solution to the roller/cylinder of an offset printing unit.

In some embodiments, the device 20 is implemented by means of an assembly of the ink jet printer head type, configured to dispense dampening solution instead of ink. The density of the nozzles in each row may be in the range of 100 to 2000 nozzles per inch (40 to 800 nozzles per centimeter), preferably between 300 and 1200 nozzles per inch (120 to 480 nozzles per centimeter). Thus, the diameter of each orifice 5 of each nozzle is in the range of 10 to 100 microns. However, even smaller diameters of the orifices could be utilized to further increase the resolution of the feeding of the dampening solution. The density of the nozzles in each row is preferably mentioned in pieces per inch, since “dpi”, or dots per inch is a common unit in printing applications.

Different types of ink jet printer heads are commercially available. The main types are thermal ink jet printer heads and piezoelectric ink jet printer heads. In a thermal ink jet printer head, a small chamber contains the amount of ink to be ejected. A heating element is provided inside the chamber, and when a current is applied to the heating element, a steam explosion causes the formation of a bubble that force a droplet of ink to be ejected from the chamber through an orifice. The surface tension of the ink as well as the contraction of the bubble contributes to a further charge of ink to be reassembled in the chamber. A channel connecting the chamber with an ink reservoir facilitates this. A piezoelectric ink jet printer head contains a chamber similar to the thermal ink jet printer head, but implements a piezoelectric element instead of the heating element. When a voltage is applied to the piezoelectric element, it expands and forces a droplet of ink to be ejected through an orifice of the chamber. Although the droplet may form a tail, which can become detached to form one or more much smaller drops, the total volume of fluid dispensed is predetermined and does not vary significantly from one ejection to the next. When the voltage is removed, the piezoelectric material retracts and the chamber is allowed to be refilled with ink. By changing either the magnitude of the applied voltage, or the duration of the applied voltage, the volume of the ejected drop may be varied. Hence, the ejected droplets may be ejected solitarily with a volume determined by the duration and character of the applied voltage and at a time determined by the timing of the applied voltage.

In other embodiments, the device 20 may be implemented by means of an array of nozzles, wherein a predetermined majority of the nozzles of the array are configured to eject a solitary droplet of dampening solution upon individual activation by a control means. Hence, in such device 20 there are a very limited number of excess nozzles. In a yet further embodiment, every nozzle of the device 20 is individually activated at the same time by the control means, i.e. no excess nozzles are present in the device 20.

When implementing a device with no or only a few excess nozzles, the lateral distance or spacing between the nozzles along the array together with the number of nozzles may be determined with regards to the desired amount of dampening solution onto the printing plate, the width of the printing plate, the nozzle diameter, the drop volume, and the ejection frequency at a specific press speed.

For ensuring sufficient drop spreading, the nozzle spacing may for example in an embodiment be determined to not exceed twice the width of the peripheral zone of deformation between the printing plate and a dampening roller 5b rotating against the printing plate. In such case, the spacing between nozzles might be approximately 0.25 inches. For providing a uniform film of 0.2 microns along the 40 inch wide printing plate, and assuming that each droplet of 8065 pico liters has a diameter of 0.01 inches, an array of 160 equally spaced nozzles would be required.

A device 20 according to the above mentioned embodiments, having no or only a few excessive nozzles may be implemented by means of an ink jet assembly. However, any suitable means for ejecting solitary droplets from an array of nozzles may be utilized, such as a piezo transducer as used in ultrasonic devices involving fluids.

In an embodiment, the time required to dispense a solitary droplet from each nozzle is between 1 and 500 microseconds and the maximum solitary droplet volume that is ejected is between 2 and 10000 pico liters. In another embodiment, the time required to dispense a solitary droplet from each nozzle is between 5 and 50 microseconds and the maximum solitary droplet volume that is ejected is between 4 and 40 pico liters. In a yet further embodiment, the maximum solitary droplet volume that is ejected is about 12 pico liters and the time required to dispense a solitary droplet from each nozzle is about 10 microseconds.

A device 20 may be created by assembling an linear array of nozzles each capable of ejecting a given maximum droplet volume, and activating them by means of a control means in such a manner that the flow of dampening fluid onto a roller/cylinder of the press, at maximum press speed is equivalent to a sheet of unit cells equal in width to the printing plate on the plate cylinder 2 and traveling at the circumferential speed of that printing plate, wherein the following conditions are achieved:
(i) each droplet of dampening fluid ejected by an active nozzle is located at the center of the unit cell;
(ii) the dimensions of the unit cell are determined so as to produce an area that is equal to the volume of the dispensed droplet divided by the desired average thickness of dampening solution fed to the press;
(iii) the number of active or utilized nozzles is determined from the dimensions of the unit cell and the width of the press while the maximum speed at which the press can be run is determined from the dimensions of the unit cell and the maximum frequency at which droplets can be ejected.

In an embodiment, the device 20 comprises a plurality of ink jet printing heads for providing a more extensive device. For example, a 42.5 inch wide device is constructed by arranging ten TIJ Wide Scan printer heads, by Hewlett Packard, adjacent to each other to create the maximum flow rate capability shown in table 1.

TABLE 1
Properties of 42.5 inch long device.

| Name of variable | Quantity | Units |
|---|---|---|
| Print head | 10 | Print heads |
| Nozzles | 10560 | Nozzles/print head |
| Capacity | 1 | Drops/nozzle |
| Max. Size | 1.2E−11 | Liters/drop |
| Max. Frequency | 24000 | Ejected/second |
| Conversion Factor | 3600 | Seconds/hour |
| Max. Flow rate | 109.5 | Liters ejected/hour |
| Conversion Factor | 0.264 | Gallons/liter |
| Max. Flow rate | 28.9 | Gallons ejected/hour |

In this embodiment the ten 4.25 inch long assembly of ink jet printer heads for feeding dampening solution are arranged in an overlapping configuration, e.g. in a two row matrix, where an ink jet printer head in the first row partially overlaps an ink jet printer head in the second row. This arrangement produces a device that in effect consists of two parallel rows of 52,800 nozzles each. While this may be far more nozzles than are actually needed, the excess nozzles can be used to advantage as illustrated in the following examples.

### Example 1

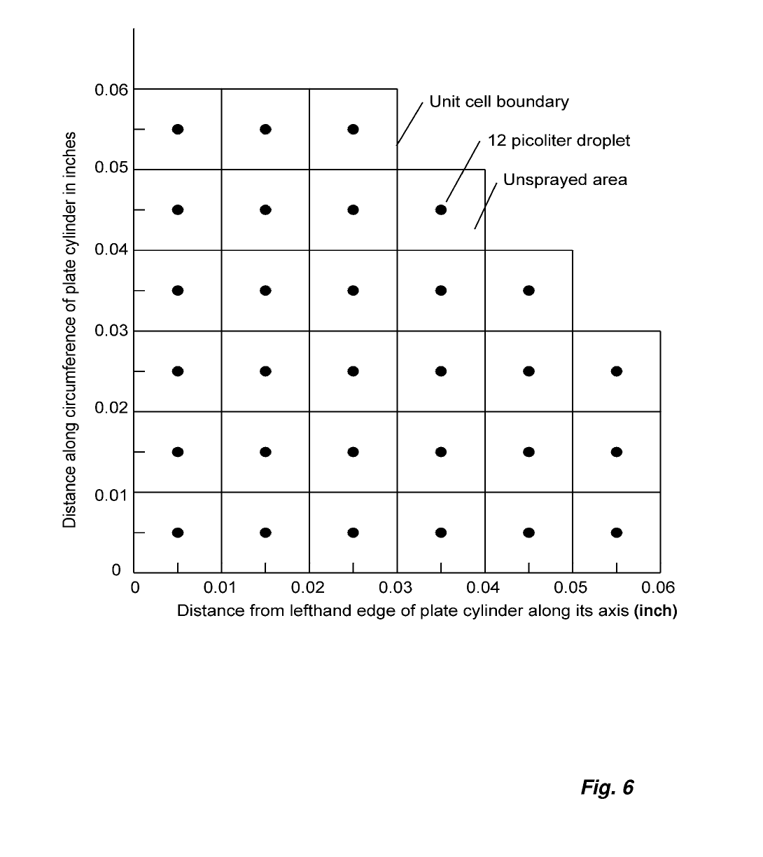

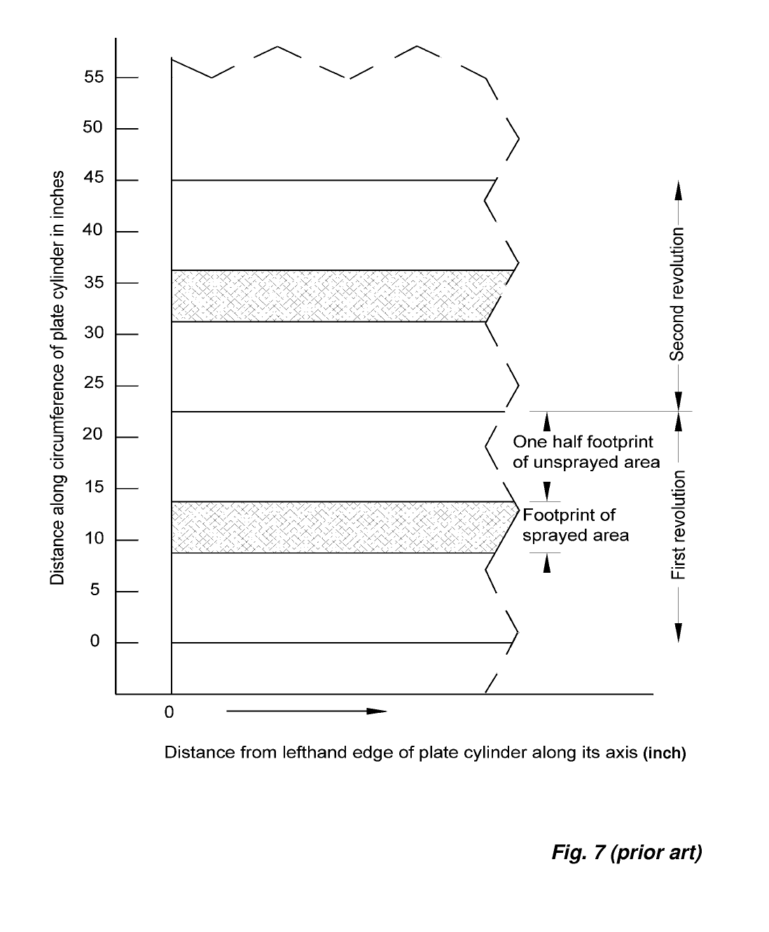

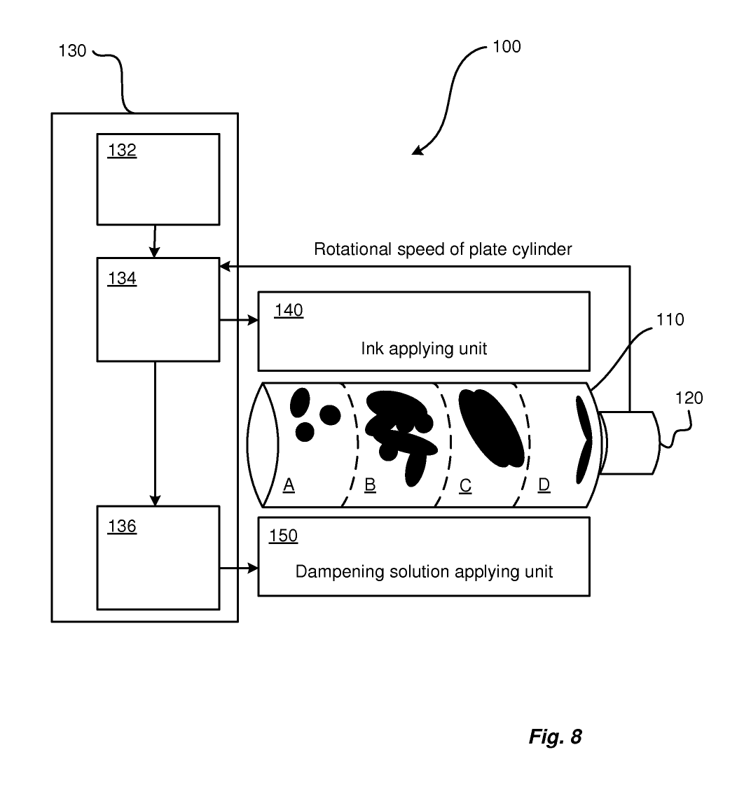

The maximum volume of the individual droplets dispensed by each nozzle in this bar is twelve pico liters. Assuming that a uniform film of dampening solution 0.2 micrometers thick is desired and that a square unit cell is to be used the dimensions of the unit cell would be 0.01 inches on a side. Given this unit cell dimension, only every 12th nozzle in one of the two rows is utilized or activated thereby creating a device 42.5 inches long, consisting of 4,250 nozzles spaced 0.01 inches apart. Thus, if the nozzles were turned on and off (pulsed) at their maximum allowable rate of 24,000 kilohertz (corresponding to an “on” time of 21 microseconds), this device could supply the required amount of dampening solution to the dampening roller or plate of a 42 inch wide press running at a speed of 1200 feet per minute, or 6 meters per second. At lower press speeds the ejecting frequency would have to be reduced accordingly. To double the maximum speed, a second group of 4250 nozzles would be run at the same frequency as the first group, but 180 degrees out of phase with it, so as to eject droplets half way between successive droplets ejected from the first group. At any given speed, the dampening solution flow rate could be varied by changing one of three variables: the pulsing frequency, the applied voltage, or the duration of the applied voltage. Alternately any combination of these three variables could be changed in unison. The improved spatial distribution or evenness of the applied dampening solution achieved with this embodiment is illustrated in FIG. 6 which is a diagram showing the pattern of droplets of dampening solution produced on the printing plate of the plate cylinder. The pattern consists of a group of the above described unit cells wherein each cell contains a single droplet of dampening solution. The small size of each unit cell means that for the droplets to be smoothed into the desired uniform film of solution, there is no particle of the solution that has to be moved over a path on the printing plate surface longer than 0.005 inches, even if it this configuration were used with a press running at a speed of 600 feet/minute. In contrast, a spray dampener typical of the current art, installed on a web press with a plate cylinder circumference of 22.5 inches, running at 1200 feet per minute, typically produces the spray pattern shown in FIG. 7. Here, for the droplets to be smoothed into the desired uniform film of solution, the maximum distance a solution particle must be moved on the plate cylinder surface is about 8.7 inches, half the length of the footprint of the unsprayed area, and well over one thousand times farther than for the described embodiment of a device for feeding dampening solution.

### Example 2

This example is similar to Example 1 except that the location of the active nozzles is shifted back and forth along the array to produce the same ejecting pattern that would result if the device were physically oscillated along its length. This would eliminate the need for oscillating one of the dampening rollers 5a, 5b.

### Example 3

In this example the same device is used to feed dampening solution directly to the printing plate of the plate cylinder and a feature is added wherein device operation is inhibited whenever the gap in the plate cylinder is in the target area of the device. Means for implementing this added feature are well known to those skilled in the art and need not be described here. This arrangement eliminates the need for any dampening rollers and prevents moisture from building up in the plate cylinder gap, which could result in corrosion of plate clamps and/or print defects.

### Example 4

This example is similar to any one of examples 1-3 above except that control means are further provided for shifting all of the active nozzles to the nozzle located immediately to their left or right. Thus if the operator or print monitoring system detects that one or more nozzles has become clogged, device operation can be quickly switched to a properly functioning group of nozzles.

In another embodiment, a less number of ink jet printer heads is arranged in a linear and/or overlapping configuration. Further, a motorized scanning unit is connected to the ink jet printer head arrangement allowing the ink jet printer heads to be scanned laterally over the length of the roller/cylinder 2, 5 during feeding of the dampening solution.

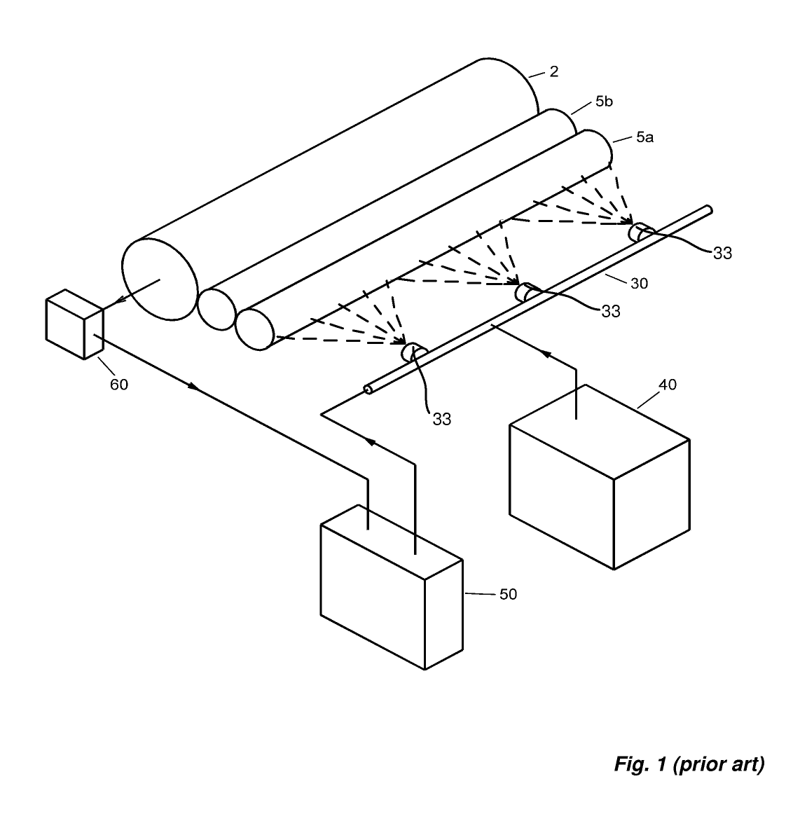

Now referring to FIG. 8, a system 100 is shown for controlling the feeding of dampening solution to an offset printing unit. The offset printing unit comprises a plate cylinder 110, an ink applying unit 140 and a dampening solution applying unit 150. The ink applying unit 140 may be any ink applying unit known per se. The dampening solution applying unit may be an arrangement 20 as described with reference to FIGS. 1 to 6. The plate cylinder 110 carries a printing plate that is divided into several cylindrical segments A, B, C, D. Each segment area A, B, C, D is hydrophilic except for hydrophobic portions, indicated by blackened areas in FIG. 8. The plate cylinder 110 is connected to a motor 120 for rotating said plate cylinder 110. A computer means 130 is provided and connected to the motor 120 for receiving the rotational speed of the plate cylinder 110. The computer means 130 comprises a memory 132 storing data related to the image to be printed, i.e. the distribution of the hydrophilic and hydrophobic areas of each segments A, B, C, D. A calculating unit 134 is also provided within said computer means 130. The calculating unit 134 is configured to calculate the amount of ink to be delivered to the plate cylinder 110 by means of the ink applying unit 140. The calculating unit uses the rotational speed of the plate cylinder and the ratio between the hydrophilic and hydrophobic areas of each segments A, B, C, D. Hence, a different volume of ink will be provided for each segment A, B, C, D. A second calculating unit 136 is also provided within the computer means 130 for determining the optimal volume of dampening solution to be delivered to the plate cylinder 110 by means of the dampening solution applying unit 140. The second calculating unit 136 receives information about the optimal volume of ink to be delivered for each segment A, B, C, D from the calculating unit 134. Hence, this information is used to directly determine the optimal volume of dampening solution for each segment A, B, C, D.

The dampening solution applying unit 150 is configured to receive the calculated volume of dampening solution to be provided to each segment A, B, C, D, and to eject the calculated volume to the plate cylinder 110. The dampening solution applying unit is capable of adjusting the ejection frequency of each nozzle, or the volume of each ejected droplet, which thereby controls the total volume to be provided to the plate cylinder 110.

Thus, according to a further aspect of the invention, a system for feeding dampening solution in an offset printing unit having a plate cylinder 110 comprises an ink applying unit 140 configured to apply ink to the plate cylinder 110, a dampening solution applying unit 150 configured to apply dampening solution to the plate cylinder 110, said dampening solution applying unit 150 comprises a device 20 having a plurality of nozzles 22 of which each nozzle comprises an orifice, each nozzle is configured to eject a solitary droplet of dampening solution through said orifice, a computer means 130 having means for determining the rotational speed of the plate cylinder, a memory unit 132 for storing data associated with the image to be printed, a first calculation unit 134 for calculating a volume of ink to be delivered to said plate cylinder, and a second calculation unit 136 for calculating a volume of dampening solution to be delivered to said plate cylinder 110, wherein said dampening solution applying unit 150 is configured to adjust the volume of delivered dampening solution by controlling the ejection frequency or the volume of said solitary droplets from each nozzle. The system is advantageous in that the optimal volume of dampening solution is delivered to each segment A, B, C, D of the plate cylinder 110 thus improving the quality of the printed image.

Several embodiments of the present invention have been described with reference to the accompanying drawings in order for those skilled in the art to be able to carry out the invention. The invention may, however, be embodied in many different forms and should not be construed as limited to the embodiments set forth herein. Rather, these embodiments are provided so that this disclosure will be thorough and complete, and will fully convey the scope of the invention to those skilled in the art. The embodiments do not limit the invention, but the invention is only limited by the appended claims. Furthermore, the terminology used in the detailed description of the particular embodiments illustrated in the accompanying drawings is not intended to be limiting of the invention.

The description focuses on an embodiment of the present invention applicable to a device for feeding dampening solution. The term “dampening solution” should be interpreted broadly, and covers all fluids used for such purpose in offset printing. Fountain solution, dampening water, water based film, fountain additive, fountain solution additive and dampening agent should all be comprised within the meaning of dampening solution.

It will be appreciated that the embodiments described in the foregoing may be combined without departing from the scope as defined by the appended claims.

Although the present invention has been described above with reference to specific embodiments, it is not intended to be limited to the specific form set forth herein. Rather, the invention is limited only by the accompanying claims and, other embodiments than the specific above are equally possible within the scope of these appended claims.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A device for feeding dampening solution in an offset printing unit, said device comprising
a plurality of nozzles, each of which comprises an orifice, wherein each nozzle is configured to eject a solitary droplet of dampening solution of a predetermined volume through said orifice to a roller/cylinder of said offset printing unit, and
a control means connected to the plurality of nozzles and programmed to allow a predetermined number of nozzles to eject solitary droplets such that a film of dampening solution is provided across hydrophobic areas and hydrophilic areas of a printing plate of said offset printing unit.

2. The device according to claim 1, wherein the time required for dispensing each solitary droplet is between 1 and 500 microseconds, preferably between 5 and 50 microseconds, most preferred about 10 microseconds, and the volume of each solitary droplet is between 2 and 10000 pico liters, preferably between 4 and 40 pico liters, most preferred about 12 pico liters.

3. The device according to claim 1, wherein said plurality of nozzles is comprised in an assembly of ink-jet type.

4. The device according to claim 1, wherein said plurality of nozzles is arranged in a linear array.

5. The device according to claim 1, wherein said plurality of nozzles is arranged in a two-dimensional matrix.

6. The device according to claim 1, wherein said plurality of nozzles is arranged longitudinally of said roller/cylinder.

7. The device according to claim 6, wherein said plurality of nozzles are controlled such that the ejected solitary droplets produce a pattern that oscillates in the lateral direction of the roller/cylinder.

8. The device according to claim 1, wherein each droplet is ejected in a plane substantially perpendicular to the surface area of said roller/cylinder.

9. The device according to claim 1, wherein said plurality of nozzles extends over the complete length of the roller/cylinder of said offset printing unit.

10. A printing unit of the offset-type, comprising a device according to claim 1.

11. A method of feeding dampening solution in an offset printing unit, comprising the steps of:
providing a device comprising a plurality of nozzles, each of which comprises an orifice,
ejecting a solitary droplet of dampening solution through each orifice of a predetermined number of nozzles to a roller/cylinder of said offset printing unit, and
equalizing the thickness distribution of the dampening solution such that a film of dampening solution is provided across hydrophobic areas and hydrophilic areas of a printing plate of said offset printing unit.

12. The method according to claim 11, wherein the time required for dispensing each solitary droplet is between 1 and 500 microseconds, preferably between 5 and 50 microseconds, most preferred about 10 microseconds and the volume of each solitary droplet is preferably between 2 and 10000 pico liters, preferably between 4 and 40 pico liters, most preferably about 12 pico liters.

13. The method according to claim 11, further comprising the step of arranging said plurality of nozzles longitudinally of said roller/cylinder.

14. Use of a device for feeding dampening solution according to claim 1.
